(19) United States
(12) Patent Application Publication
(10) Pub. No.: US 2002/0119790 A1
(43) Pub. Date: Aug. 29, 2002

(54) Method and apparatus for using position location to direct narrow beam antennas

(76) Inventors: Bruce A. Judson, San Luis Obispo, CA (US); Christopher C. Riddle, San Diego, CA (US)

Correspondence Address: QUALCOMM Incorporated, 5775 Morehouse Drive, San Diego, CA, 92121-1714, US

(21) Appl. No.: 09/989,875

(22) Filed: Nov. 20, 2001

Related U.S. Application Data
(60) Provisional application No. 60/249,870, filed on Nov. 16, 2000.

(51) Int. Cl. H04Q 7/20

(52) U.S. Cl. 455/456; 455/427; 455/12.1

(57) ABSTRACT

A novel mobile unit which communicates with a new and advantageous base station. The mobile unit includes a system for generation of position information and a transceiver for transmitting the position information. In the preferred embodiment, the transceiver is a CDMA system and the system for generating position information includes an arrangement for receiving a GPS signal. In the preferred embodiment, a GPS assisted arrangement is employed which is adapted to receive a signal from an airborne platform as well as from a satellite based platform. The inventive base station is adapted to receive position information from a remote unit and provide a received position signal in response thereto. The novel base station is further equipped with a mechanism for directing a beam in response to the received position signal. In the illustrative embodiment, the mechanism for directing the beam is a smart antenna system including an antenna array and a beamforming network for driving the array to output the directed beam.

### RELATED APPLICATIONS

This application claims priority to U.S. Provisional Application No. 601249,870, filed on Nov. 16, 2000. This application also claims priority to U.S. patent application Ser. No.______, filed on Nov. 15, 2001 (Attorney Docket No. 000192).

### BACKGROUND OF THE INVENTION

1. Field of the Invention

The present invention relates to communications systems and methods. More specifically, the present invention relates to systems and methods for improving the performance of cellular telephone systems.

2. Description of the Related Art

Cellular telephone systems are characterized by a number of base stations, each of which is equipped with a transceiver. The transceiver is conventionally connected to an antenna arrangement that provides a coverage area or “cell”. The conventional antenna arrangement typically includes three antennas, each of which radiate energy over a 120° arc to provide the 360° coverage required for the cell.

Smart antennas are arrays of antenna elements, each of which receive a signal to be transmitted with a predetermined phase offset and relative gain. The net effect of the array is to direct a (transmit or receive) beam in a predetermined direction. The beam is steered by controlling the phase and gain relationships of the signals that excite the elements of the array. Thus, smart antennas direct a beam to each individual mobile unit (or multiple mobile units) as opposed to radiating energy to all mobile units within a predetermined coverage area (e.g., 120°) as conventional antennas typically do. Smart antennas increase system capacity by decreasing the width of the beam directed at each mobile unit and thereby decreasing interference between mobile units. Such reductions in interference result in increases in signal-to-interference and signal-to-noise ratios that improved performance and/or capacity. In power controlled systems, directing narrow beam signals at each mobile unit also results in a reduction in the transmit power required to provide a given level of performance.

While smart antennas effectively improve the capacity of a system, such systems require a method for determining where to direct the beam. In the reverse link (i.e., the signal from the mobile unit to the base station), the angle of arrival of energy transmitted by the mobile unit may be used to calculate the direction in which the beam should be directed. Unfortunately, current techniques for calculating angle of arrival information require complex computations and furthermore are subject to measurement error due to noise and interference introduced by the channel. In addition, systems that perform angle of arrival computations works best in environments where energy is received from the mobile unit via a “line of sight”. Unfortunately, in some environments (e.g., urban environments) signals transmitted from mobile units often reflect off buildings and other structures and are therefore received by base stations as a multipath signal.

For a CDMA based system, an optimal solution (from a mobile unit capacity perspective) for determining how to direct the beams of a smart antenna is achieved by maximizing the signal-to-noise-plus-interference ratio. Typical methods, such as the “optimal Wiener solution”, are relatively complex, costly and result in potential time delays within the system. FIG. 1 is a flow diagram of one such beamforming algorithm implemented in accordance with a conventional Minimum Mean Squared Error Algorithm.

The process 100 includes detecting the mobile unit's request for access to the system (STEP 110) and generation of a pilot signal in response to the request (STEP 120). A received signal vector is sampled (STEP 130) and used to generate an equation of the beamformer output (STEP 140). An error function is generated between the pilot signal and the beamformer output (STEP 150). Next, the error function is minimized using the Wiener-Hopf equation or the optimum Wiener solution (STEP 160). Finally, the optimized weights are applied to the beamformer (STEP 170). In accordance with this process, eigenvalues must be calculated and other operations involving linear algebra must be performed. These calculations and operations result in numerous processor operations.

Hence, a need remains in the art for an efficient method and apparatus for increasing system capacity for cellular telephone systems without the need for complex computation. In addition, there is a need for a system that is robust in environments in which multipath signals are often received by base stations from mobile units and in environments where a significant amount of noise and interference is added by the channel.

### SUMMARY OF THE INVENTION

The need for an efficient method and apparatus for increasing system capacity for cellular telephone systems without the need for complex computation and that is robust in environments in which multipath signals are often received is satisfied by the teachings of the present disclosure. The inventive method and apparatus disclosed herein includes both a mobile unit and a base station. The mobile unit includes a system for generating position information and a transceiver for transmitting the position information. In the preferred embodiment of the disclosed method and apparatus, the transceiver is a preferably implemented as a CDMA (Code Division Multiple Access) transceiver. The system for generating position information preferably includes a receiver for receiving signals from Global Positioning System (GPS) satellites.

The base station receives position information from a remote unit and responds by transmitting a forward link signal in a narrow beam in the direction of the position indicated by the received position information. The direction in which the forward link signal is transmitted may also be determined by taking into account terrain data that is available to the base station. In the illustrative embodiment, the mechanism for directing the beam is a smart antenna system including an antenna array and a beamforming network.

### BRIEF DESCRIPTION OF THE DRAWINGS

FIG. 1 is a flow diagram of one such beamforming algorithm implemented in accordance with a conventional Minimum Mean Squared Error Algorithm.

FIG. 2A is a block diagram showing one sector of a basic conventional cellular system.

FIG. 2B is a diagram of a cellular telephone system utilizing a smart antenna system.

FIG. 3 is a block diagram of a mobile unit in accordance with the present teachings.

FIG. 4 is a simplified block diagram of a base station in accordance with the presently disclosed method and apparatus, a public switched telephone network (PSTN), and a switch.

FIG. 5 is a simplified block diagram of the smart antenna processor.

FIG. 6 is a flow diagram of an algorithm used to form beams.

FIG. 7 is a flow diagram of a spatial processing method.

It should be understood that throughout the present description, like reference numbers are to refer to like elements.

### DESCRIPTION OF THE INVENTION

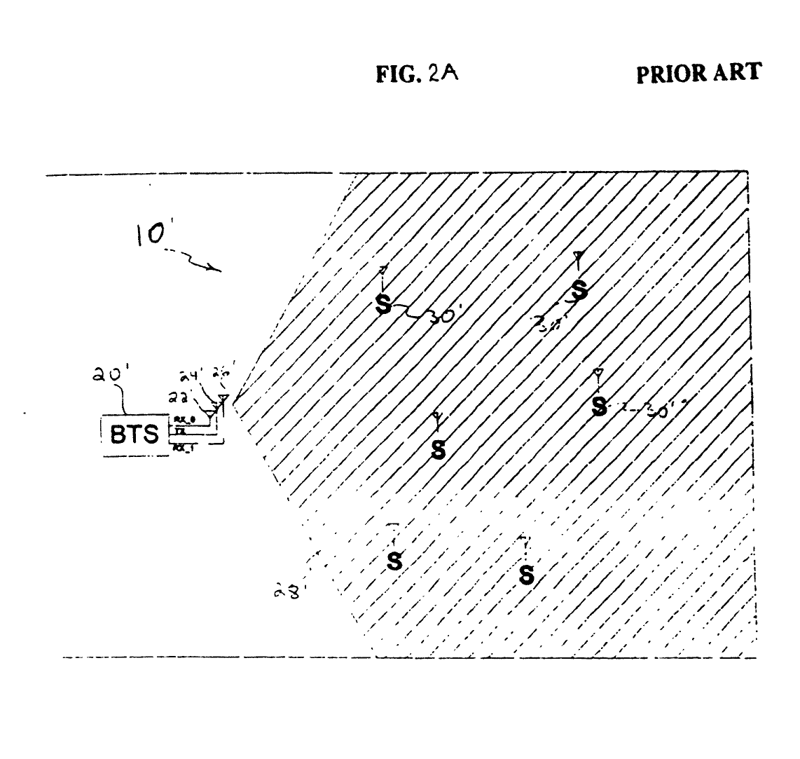

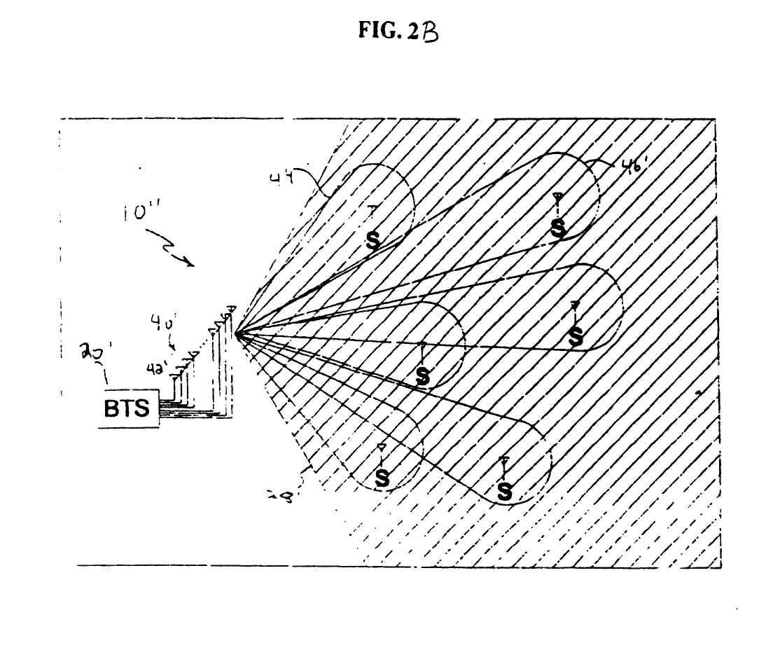

FIG. 2A is a block diagram showing one sector of a basic conventional cellular system. The system 10 includes a base station 20 that transmits and receives signals to and from a plurality of subscriber units 30 via three sets of sector antennas. Each such set of sector antennas includes three antennas 22, 24 and 26, one transmit (forward link) antenna 26 and two diversity (return link) antennas, 22 and 24, as is common in the art. Each antenna is designed to provide coverage in an area 28 having a vortex at the base station and emanating out at an angle of 120°. The area of coverage 28 provided by the three antennas (e.g., 26, 22, 24) in FIG. 2A is shaded. Three such antenna sets are typically used to provide 360° coverage in order to cover the entire cell. While this approach has been effective, the capacity of such a system is somewhat limited. As mentioned above, smart antennas can increase the capacity of a cellular telephone system.

FIG. 2B is a diagram of a cellular telephone system utilizing a smart antenna system. The system 10′ of FIG. 2B is similar to that shown in FIG. 2A with the exception of a smart antenna array 40 in lieu of the three sector antennas 22, 24 and 26 of FIG. 2A. The coverage area 28 of the conventional system depicted in FIG. 2B is shown for comparison. As shown in FIG. 2B, smart antennas are arrays of antenna elements 42, each of which receive a signal to be transmitted with a predetermined phase offset and relative gain. The net effect of the array 40 is to direct a transmit or receive beam 44 in a predetermined direction. Each beam is controllable by controlling the phase and gain relationships of the signals used to excite (or received from) the elements 42 of the array 40. Thus, smart antennas direct a beam to each individual mobile unit as opposed to radiating energy to (or receiving energy from) all mobile units within a predetermined coverage area (e.g., 120°) as per conventional antennas. Hence, smart antennas increase system capacity by decreasing the beam width to each mobile unit and thereby decreasing the amount of interference between mobile units. With a reduction in interference, an increase in signal-to-interference and signal-to-noise ratio results allowing for improved performance and/or capacity.

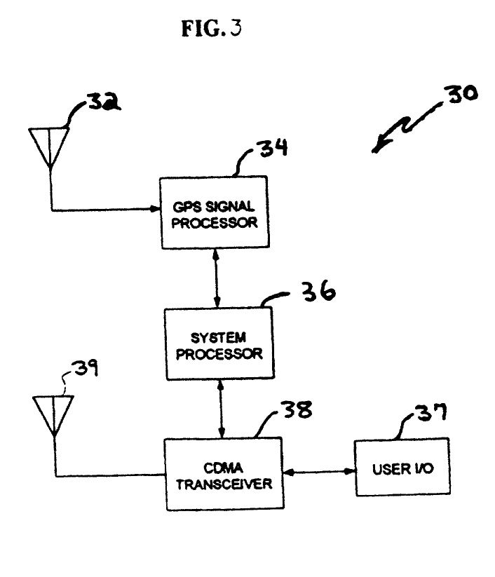

FIG. 3 is a block diagram of a mobile unit 30 in accordance with the present teachings. The mobile unit 30 includes a first antenna 32 adapted to receive position location signals from a remote system such as the Global Positioning System. Signals from the GPS antenna 32 are processed by a GPS signal processor 34. The GPS processor 34 outputs position data to a system controller 36. The system controller 36 selectively multiplexes the position data. The position data is provided via a mobile unit interface 37 for transmission by a transceiver 38 through the antenna 39. In one embodiment of the presently disclosed method and apparatus, the transceiver 38 is a code division multiple access (CDMA) transceiver. However, those of ordinary skill in the art will appreciate that the invention is not limited to CMDA transceivers. The present teachings may be utilized with other communications technologies such as Time Division Multiple Access (TDMA) or Global System for Mobile (GSM) without departing from the scope of the present teachings

As discussed more fully below, in one embodiment of the disclosed method and apparatus, GPS data is received at the base station 20. Assistance data is derived from the received GPS data. The assistance data is transmitted to the mobile unit 30. The mobile unit 30 uses the assistance data to shorten the amount of time required to acquire GPS satellites. Position location data is transmitted by the array 40 to the base station 20.

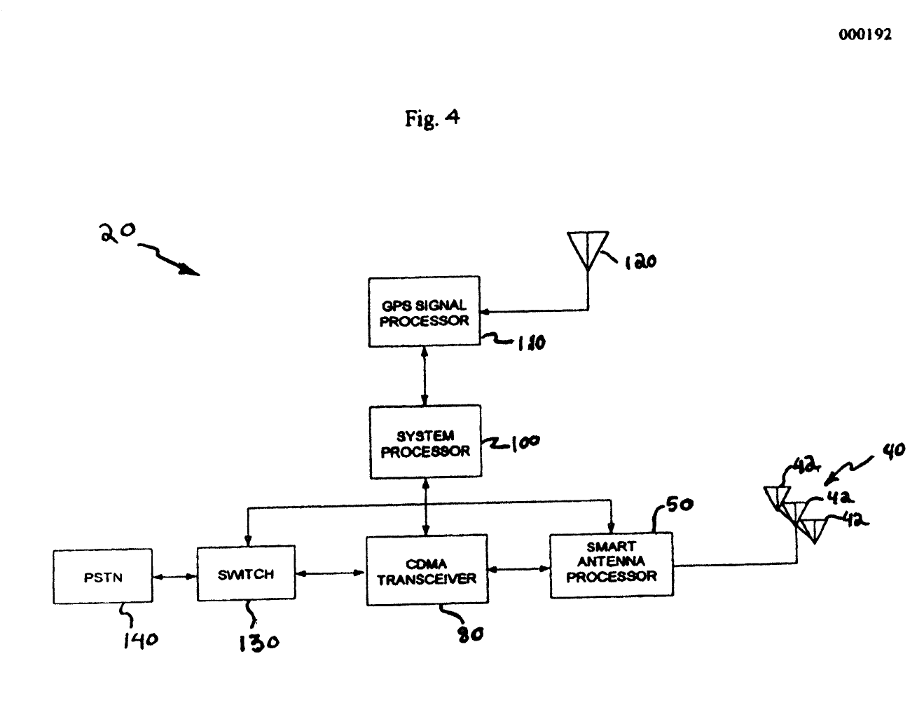

FIG. 4 is a simplified block diagram of a base station 20 in accordance with the present teachings, a public switched telephone network (PSTN) 140, and a switch 130. The base station 20 includes a GPS antenna 120, a GPS signal processor 100, a CDMA transceiver 80, a smart antenna processor 50, and an array of antennas 40 comprising spatially localized radiating elements 42. The PSTN provides connections between the base station 20 and other devices connected to the telephone network. The switch 130 provides the necessary switching logic to ensure that the connection between the base station 20 and the PSTN is made properly.

GPS signals are received by the GPS antenna 120. These signals are coupled to the GPS signal processor 110. The GPS signal processor 110 generates position location data from the received GPS signals. The GPS signal processor is coupled to the system processor 100. The system processor 100 provides position data to the smart antenna processor 50.

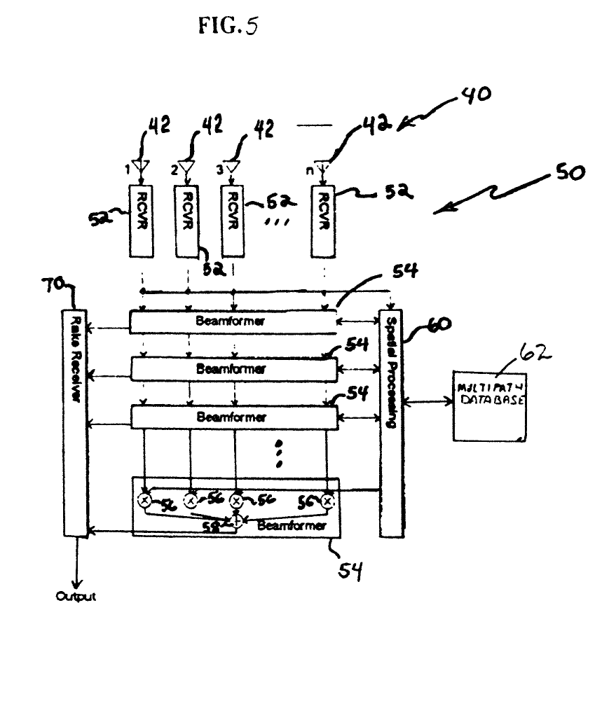

FIG. 5 is a simplified block diagram of the smart antenna processor 50. The smart antenna processor 50 includes a plurality of receivers 52, a number of beamforming elements 54, a spatial processor 60 and a Rake receiver 70. In one embodiment shown in FIG. 5, the smart antenna processor 50 also includes a multipath database 62. As discussed more fully below, the smart antenna processor 50 utilizes the position data to steer beams that are output by the antenna array 40. In one embodiment of the disclosed method and apparatus, the smart antenna processor 50 also uses local terrain information to steer the beams. In accordance with one embodiment of the disclosed method and apparatus, the antenna array 40 forms a conventional phased array antenna. Each of n elements 42 of the antenna array 40 feeds an associated one of n receivers 52. In the illustrative embodiment, each receiver 52 downconverts and demodulates the signal received by the element 42 and performs matched filtering appropriate for the signals was received. Consequently, each receiver 52 accepts a radio frequency (RF) input signal from an antenna element 42 and processes the received signal. Accordingly, each receiver 52 outputs a received baseband signal. It should be noted that at this point in the system, no beamforming has been performed. Therefore, the baseband signal is a composite signal including baseband information from a number of sources that will be separated during the beamforming process.

Each receiver 52 is connected to all of the beamformers 54 and a spatial processing unit 60. Each beamformer 54 includes a set of complex multipliers 56 and a summing circuit 58. The beamformers 54 each accept the baseband signals from the receivers 52. Each complex multiplier 56 multiplies the received baseband signal by a complex weight provided by the spatial processing unit 60. The beam is formed by summing the complex-multiplied samples with an adder 58 in each beamformer 54. Each beamformer 54 performs this operation for one beam. Due to the fact that the signal from one particular mobile unit 30 may arrive at the base station 20 over several distinct paths, there are typically multiple beams per mobile unit 30. In addition, there are typically many mobile units 30.

The summed signals are supplied to the rake receiver 70. The rake receiver 70 accepts the outputs of the beamformers 54. Since there may be multiple beams associated with one mobile unit 30, the rake receiver 70 delays and combines signals received in beams that are directed at the same mobile unit 30. This delaying and combining operation is performed in an optimal fashion to ensure that energy that is transmitted from a mobile over an indirect path is combined with energy from other indirect paths as well as energy transmitted over the direct path between the mobile unit 30 and the base station 20. This delaying and combining operation takes place under the control of the spatial processing unit. Accordingly, the spatial processing unit 60 is not only responsible for determining the characteristics of the beams to be formed, but also for determining which beams are to be combined in the rake receiver. The spatial processing unit 60 implements an advantageous beamforming algorithm in accordance with the present teachings as discussed more fully below.

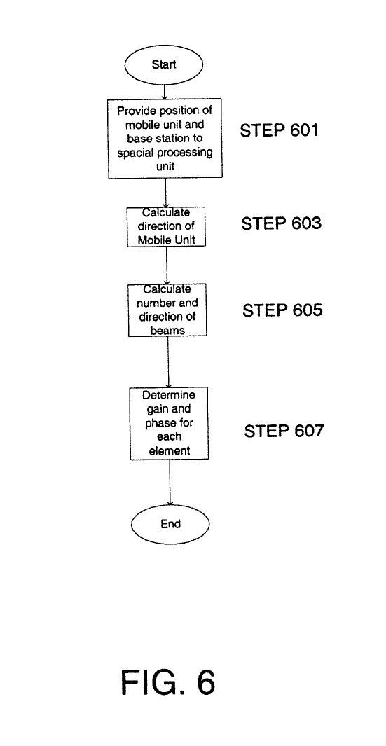

In many cases, a “near optimal” solution can achieve satisfactory results. Such a near optimal solution requires far less complexity, cost and and amount of processing then solutions that require eigenvalues to be calculated and that require linear algebra to be performed. One such near optimal solution is illustrated in FIG. 6, which will be described in detail below.

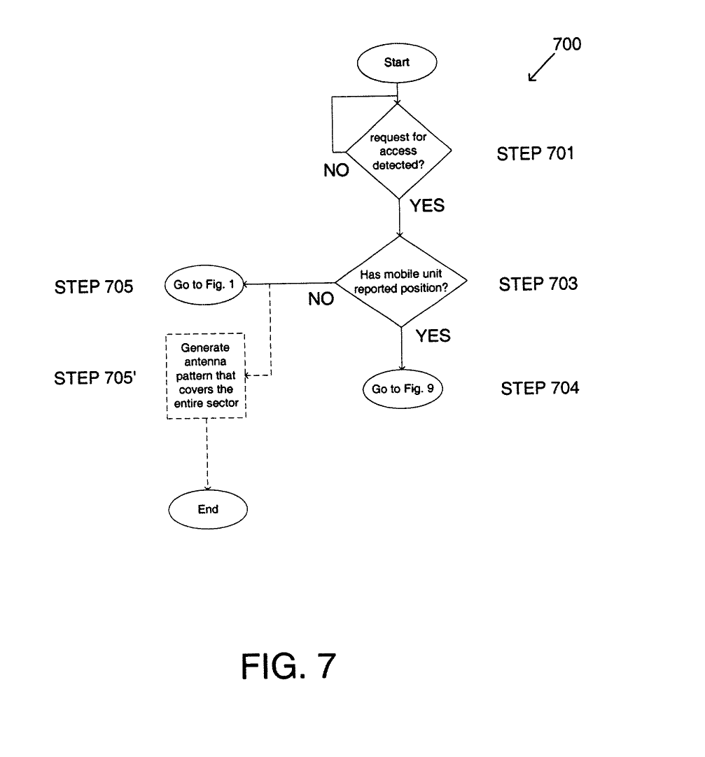

FIG. 7 is a flow diagram of a spatial processing method 700. The method 700 uses the position of the mobile unit 30 when available (and in one embodiment, local terrain data) to determine the beamformer weights. Alternatively, if the position of the mobile unit 30 is not available, then a method that does not require knowledge of the position of the mobile unit 30 is used. The method 700 and begins when a request for access to the system by the mobile unit 30 is detected by the base station 20 (STEP 701). If the mobile unit 30 reports his position (STEP 703), then the algorithm shown in FIG. 6 is used to generate the beamformer weights (STEP 704).

FIG. 6 is a flow diagram of an algorithm used to form beams (i.e., determine the beamformer weights of the beams) directed to a mobile unit 30 that knows its position and the position of the base station 20. The position of the mobile unit 30 and the position of the base station 20 are provided to the spatial processing unit 60 (FIG. 5) (STEP 601). The spatial processing unit 60 calculates the direction of the mobile unit 30 with respect to the base station 20 (STEP 603). Those skilled in the art will appreciate that the present teachings are not limited to the manner by which the mobile unit's position is determined. Any technique may be used to determine the position of the mobile unit 30 and the base station 20 without departing from the scope of the present teachings. The direction of the mobile unit 30 is calculated by converting the GPS coordinate data to beamforming coordinate data and by using trigonometric techniques well-known to those skilled in the art.

Next, the number and direction of the beams is calculated (STEP 605). One method for calculating the number and direction of the beams to be used relies on information supplied by a multipath database 62 (see FIG. 5). In one embodiment of the disclosed method and apparatus, the database is based on an analysis of the signals that can be received throughout the sector 28 (see FIG. 2). Alternatively, a measurement is performed by driving throughout the coverage area and measuring the angle of arrival of the signals received. The mobile position and angle of arrival of the energy are logged in the database 62 for use later. Finally, the gain and phase of the signals to be transmitted by each element 42 of the antenna array 40 (i.e., the beamforming weights) are determined using antenna array characteristics such as the distance between the elements 42 and the gain of each element 42 (STEP 607).

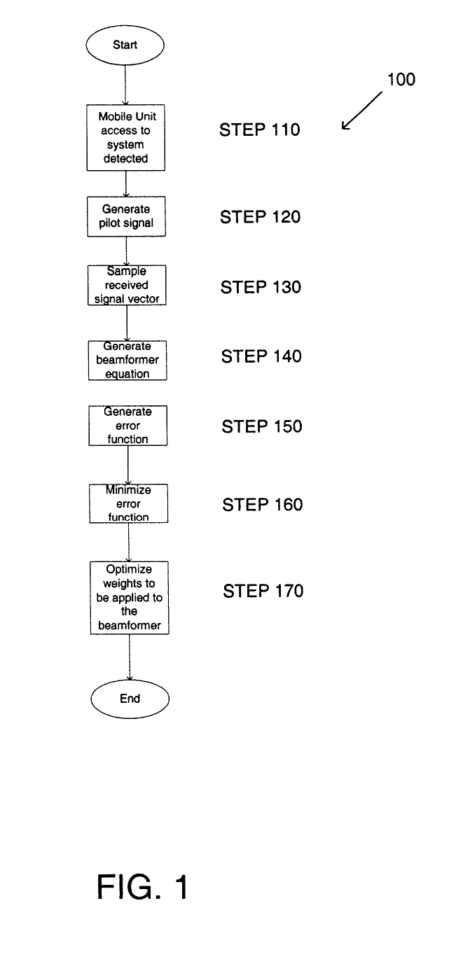

Returning to FIG. 7, if the mobile unit does not report its location (STEP 703), the system uses an algorithm such as that shown in FIG. 1 (STEP 705). Alternatively, the system may perform an algorithm that generates a pattern that covers the entire sector (STEP 705).

Returning to FIG. 5, the output of the smart antenna processor 50 is input to a transceiver 80 of design and construction compatible with the transceiver 38 of the mobile unit 30. The transceiver 80 communicates with an external network such as the PSTN 140 via the switch 130.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention. While the disclosed method and apparatus is described herein with reference to illustrative embodiments for particular applications, it should be understood that the invention is defined by the claims appended to this disclosure. Those having ordinary skill in the art and access to the presently disclosed method and apparatus will recognize additional modifications, applications, and embodiments within the scope of the claimed invention. Furthermore, those skilled in the art will note that there may be additional fields in which the present invention would be of significant utility.

Accordingly,

What is claimed is:

1. A mobile transceiver having:
a system for generation of position information and
means for transmitting said position information.

2. The invention of claim 1 wherein said system for generation of position information includes means for receiving a signal from a satellite.

3. The invention of claim 2 wherein said system for generation of position information includes means for receiving a Global Positioning System signal.

4. The invention of claim 1 wherein said system for generation of position information includes means for receiving a signal from an airborne platform.

5. The invention of claim 1 wherein said means for transmitting said position information includes a CDMA transmitter.

6. A base station having:
means for receiving position information from a remote unit and providing a received position signal in response thereto and
means for directing a beam in response to said received position signal.

7. The invention of claim 6 wherein said position information is provided at least in part by a Global Positioning System.

8. The invention of claim 7 wherein said remote unit is a mobile transceiver.

9. The invention of claim 8 wherein said mobile transceiver is a CDMA transceiver.

10. The invention of claim 8 wherein said beam is directed to said transceiver.

11. The invention of claim 6 wherein said means for directing a beam includes a smart antenna.

12. The invention of claim 11 wherein said means for directing a beam includes an antenna array.

13. The invention of claim 12 further including means for driving said array to output a directed beam.

14. The invention of claim 13 wherein said means for driving includes a beamforming network.

15. A cellular communications system comprising:
a mobile transceiver having:
a GPS system for generation of position information and means for transmitting said position information and
a base station having:
means for receiving said position information and providing a received position signal in response thereto and
means located at said base station for directing a beam in response to said received position signal.

16. The invention of claim 15 wherein said GPS system is GPS assisted.

17. The invention of claim 15 wherein said means for directing a beam includes a smart antenna.

18. The invention of claim 17 wherein said means for directing a beam includes an antenna array.

19. The invention of claim 18 further including means for driving said array to output a directed beam.

20. The invention of claim 19 wherein said means for driving includes a beamforming network.

21. A method for effecting directional cellular communications including the steps of:
generating position information at a mobile transceiver;
transmitting said position information;
means for receiving said position information at a base station and providing a received position signal in response thereto; and
directing a beam from said base station to said mobile transceiver in response to said received position signal.
